(19) United States
(12) Patent Application Publication
(10) Pub. No.: US 2025/0376181 A1
(43) Pub. Date: Dec. 11, 2025

(54) Selection Device for Driver Assistance Functions of a Vehicle With Adaptation of an Operating Element of a Multifunctional Steering Wheel, Vehicle, and Method

(71) Applicant: Bayerische Motoren Werke Aktiengesellschaft, Muenchen (DE)

(72) Inventors: Walter KAGERER, Muenchen (DE); Frederik PLATTEN, Muenchen (DE); Wolfgang SPIESSL, Freising (DE)

(21) Appl. No.: 18/877,038

(22) PCT Filed: Jun. 16, 2023
(86) PCT No.: PCT/EP2023/066266

§ 371 Date: Dec. 19, 2024

(30) Foreign Application Priority Data
Jun. 22, 2022 (DE) 10 2022 115 593.5

(51) Int. Cl. B60W 50/08; B60W 30/14; B60W 50/14; B62D 1/04

(52) U.S. Cl. CPC B60W 50/082; B60W 30/146; B60W 50/14; B62D 1/046; B60W 2050/146; B60W 2540/215; B60W 2720/10

(57) ABSTRACT

A selection device for driver assistance functions of a vehicle includes a multifunction steering wheel with an operating element. A display and a driver assistance function are assigned to the operating element and are settable. In a first equipment variant of the vehicle, comprising a first driver assistance function, a control unit controls the display to display a first display assigned to the first driver assistance function and to activate and/or deactivate the first driver assistance function upon the operation of the operating element. In a second equipment variant of the vehicle, comprising the first and a second driver assistance function, the control unit controls the display to display a second display assigned to the second driver assistance function and to activate and/or deactivate the second driver assistance function upon the operation of the operating element.

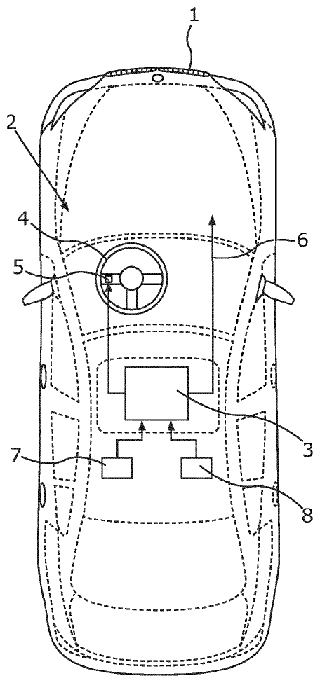

### BACKGROUND AND SUMMARY

The present invention relates to a selection device for driver assistance functions of a vehicle. In addition, the present invention relates to a vehicle having such a selection device. Finally, the present invention relates to a method for operating a selection device for driver assistance functions of a vehicle.

Different driver assistance systems or driver assistance functions are known from the prior art, which can assist a driver in guiding the vehicle. For example, driver assistance functions are known which display the current permissible highest speed to the driver. For this purpose, for example, traffic signs can be detected using a camera of the vehicle. This function can moreover be expanded by the speed regulation or a longitudinal regulation. For example, if the driver has selected the takeover of the speed limit with activated speed regulation, the driver assistance system automatically adapts the speed to the signage or the currently permissible highest speed.

Furthermore, so-called speed limiters are known from the prior art. Using this driver assistance function, a speed limit can be set by the driver, for example, so as not to exceed the permissible highest speed. In addition, it is known that a detected change of the permissible highest speed is taken over for the speed limiter as the new speed limit.

Furthermore, speed regulation with distance regulation is known from the prior art. This function can also be designated as adaptive speed regulation or as adaptive cruise control (ACC). This function can moreover automatically determine the distance or safety distance to a road user traveling ahead and can adapt the speed of the vehicle accordingly. Moreover, a target speed or set speed can be specified by the driver, which is not exceeded by the vehicle.

To meet future requirements, for example, requirements of the Euro NCAP, for example, the speed limiter has to be present in the vehicle and activatable using a simple operating action. The speed limiter is typically activated by a corresponding operation of an operating element on the multifunction steering wheel. It is also possible to meet the requirements with respect to the speed limiting using a higher-value driver assistance function. This can be, for example, a variant of the adaptive cruise control.

It is the object of the present invention to disclose a solution for how the operation or the selection of multiple driver assistance functions in a vehicle can be facilitated for the user.

This object is achieved according to the invention by a selection device, by a vehicle, and by a method having the features according to the independent claims. Advantageous refinements of the present invention are specified in the dependent claims.

A selection device according to the invention for driver assistance functions of a vehicle comprises a multifunction steering wheel, which has an operating element, wherein a display assigned to the operating element on the multifunction steering wheel and a driver assistance function assigned to the operating element are settable. Furthermore, the selection device comprises a control unit for controlling the display assigned to the operating element and for activating and/or deactivating the driver assistance function of the vehicle assigned to the operating element as a result of an operation of the operating element. The control unit is configured here, in a first equipment variant of the vehicle, which comprises a first driver assistance function, to display a first display assigned to the first driver assistance function and to activate and/or deactivate the first driver assistance function upon the operation of the operating element. Furthermore, the control unit is configured, in a second equipment variant of the vehicle, which comprises the first driver assistance function and the second driver assistance function, to display a second display assigned to the second driver assistance function and to activate and/or deactivate the second driver assistance function upon the operation of the operating element.

The control of the various driver assistance functions in the vehicle can be set by means of the selection device. The selection device comprises the multifunction steering wheel, which has the operating element. The operating element can be a button, a knob, a turn-press controller, a touch sensitive surface, a touchscreen, or the like. In principle, however, it is provided that the multifunction steering wheel has a plurality of operating elements. The operating element can be dynamically occupied. This means that a changeable display is assigned to the operating element. This display can be arranged, for example, directly on or at the operating element. It can also be provided that the display is arranged on the multifunction steering wheel adjacent to or in the immediate surroundings of the operating element. The display can be a symbol, a text, a graphic, or the like.

The occupancy of the operating element can be controlled by means of the control unit. This means in particular that the display associated with the operating element can be adapted or changed by means of the control unit. For example, a plurality of displays can be predetermined and one of these displays can be selected by means of the control unit. In addition, the driver assistance function, which is activated and/or deactivated as a result of the operation of the operating element, can be selected by means of the control unit.

According to the present invention, it is now provided that in the first equipment variant of the vehicle, which only comprises the first driver assistance function, a first display assigned to the first driver assistance function is displayed on the multifunction steering wheel by means of the control unit as the display. Moreover, in this first equipment variant, the functional linkage is selected by means of the control unit so that upon the operation of the operating element by the driver, only the first driver assistance function can be activated and/or deactivated.

In the second equipment variant of the vehicle, which comprises both the first driver assistance function and the second driver assistance function, only a second display, which is assigned to the second driver assistance function, is displayed on the multifunction steering wheel or the operating element. Furthermore, it is provided that upon the operation of the operating element, only the second driver assistance function can be activated and/or deactivated. In the second equipment variant, in particular in a base setting, the first display is thus not displayed on the multifunction steering wheel or the operating element. In this way, it is possible to prevent excessively many options for operation being present on the multifunction steering wheel. The operation can thus be simplified for the driver.

Preferably, the first driver assistance function is a speed limiter and the second driver assistance function is an adaptive speed regulation. It is thus preferably provided that the vehicle according to the first equipment variant only comprises a so-called speed limiter. In this case, the letters “LIM” can be displayed as the first display on the multifunction steering wheel or the operating element. If the vehicle also comprises the adaptive speed regulation in addition to the speed limiter as the second equipment variant, the symbol “ACC” can be displayed on the multifunction steering wheel or the operating element as the second display. If no ACC is present in the vehicle according to the first equipment variant of the vehicle, a LIM button can be displayed on the multifunction steering wheel which activates the speed limiter. If ACC is present in the vehicle according to the second equipment variant, an ACC symbol can be displayed on the multifunction steering wheel in the base state, but no longer the LIM symbol. In the second equipment variant, an assisting steering function or an automated lateral guidance can also be provided optionally or directly.

It is provided in particular according to the second equipment variant of the vehicle that the adaptive speed regulation is designed in such a way that a target speed or set speed can be specified therein by the driver. This set speed can correspond to a speed limit for the operation of the vehicle. Furthermore, the set speed can correspond to a target speed which the speed regulator regulates for the adaptive speed regulation. This target speed can be overridden by the driver, for example, by activating the accelerator pedal. Overall, the legal requirements, in particular the requirements of Euro NCAP can be met. Independently of the equipment variant, the respective driver assistance function can be offered on the multifunction steering wheel and simple operation can be enabled for the user or driver by the selection device according to the invention.

In a further embodiment, the selection device is configured to acquire information about exceeding the permissible highest speed and to display the first display in dependence on the acquisition and to activate the first driver assistance function upon actuation of the operating element. As already explained at the outset, the permissible highest speed, which applies for the currently traveled roadway section, can be detected on the basis of traffic signs detected using the camera. If it is established, for example, that the driver often drives faster than the limit permitted on this roadway section, in principle a notification of the activatable speed limiter can then be displayed. This applies both to the first equipment variant, in which only the speed limiter is present, and for the second equipment variant, in which speed limiting is enabled via the adaptive speed regulation. This display can be output on an arbitrary display device of the vehicle. Alternatively or additionally, the setting for the speed limiter can be activated so that the function of the speed limiting is visible on the multifunction steering wheel. In this way, the driver can be assisted in a reliable manner in the activation of the speed limiting. This is suitable in particular in the second equipment variant, in which the function of the speed limiter is not directly apparent to the driver or user. In this constellation, the speed behavior of the driver can be observed as described above.

In a further embodiment, the selection device has an input device, by means of which the display and/or the function assigned to the operating element are settable. According to the second equipment variant, the driver can directly activate ACC, for example, via the operating element on the steering wheel, but no longer the speed limiter. In this case, a setting menu can be offered to the driver, using which the speed limiter can additionally be activated again directly by the operating element on the multifunction steering wheel. If this setting is set or is selected by the driver, both ACC and LIM can be displayed on the multifunction steering wheel and both functions are operable by the driver. In principle, it is possible for the user to select from different displays and functions linked thereto via the operation at the input device. The input device can be arranged on the multifunction steering wheel or also separately therefrom.

In a further embodiment, the selection device is configured to detect a change from the first equipment variant to the second equipment variant and to display the second display upon the detected change and to activate and/or deactivate the second assistance function upon the operation of the operating element. In principle, the equipment variants of the vehicle can result from the factory or from the purchase of the vehicle. For example, during the manufacturing of the vehicle or before the delivery of the vehicle, corresponding information can be stored in the control unit which describes the installed equipment variant of the vehicle. However, it can also be provided that the driver or the customer acquires the second equipment variant in a subsequent purchase and/or a so-called over-the-air update. If this is the case, this can advantageously be detected by means of the control unit or the selection device and thus the display which is assigned to the operating element and also the function linked to the operating element can be adapted. This also applies in the same manner for a change from the second equipment variant to the first equipment variant.

A vehicle according to the invention comprises a selection device according to the invention. The vehicle is in particular designed as a passenger vehicle. Moreover, the vehicle can have corresponding driver assistance systems, using which the driver assistance functions can be carried out.

A method according to the invention is used to operate a selection device for driver assistance functions of a vehicle. The method comprises providing a multifunction steering wheel which has an operating element, wherein a display assigned to the operating element and a driver assistance function assigned to the operating element are settable. In addition, the method comprises controlling the display assigned to the operating element and activating and/or deactivating the driver assistance function of the vehicle assigned to the operating element as a result of an operation of the operating element. It is furthermore provided that in a first equipment variant of the vehicle, which comprises a first driver assistance function, a first display assigned to the first driver assistance function is displayed and the first driver assistance function is activated and/or deactivated upon the operation of the operating element. In a second equipment variant of the vehicle, which comprises the first and the second driver assistance function, a second display assigned to the second driver assistance function is displayed and the second driver assistance function is activated and/or deactivated upon the operation of the operating element.

The preferred embodiments presented with reference to the selection device according to the invention and the advantages thereof apply accordingly to the vehicle according to the invention and to the method according to the invention.

Further features of the invention result from the claims, the FIGURE, and the description of the FIGURE. The features and combinations of features mentioned above in the description and the features and combinations of features mentioned hereinafter in the description of the FIGURE and/or solely shown in the FIGURE are usable not only in the respective specified combination, but also in other combinations or alone, without departing from the scope of the invention.

### BRIEF DESCRIPTION OF THE DRAWING

The FIGURE shows a schematic representation of a vehicle which has a selection device.

### DETAILED DESCRIPTION OF THE DRAWING

The FIGURE shows a vehicle 1, which is designed in the present case as a passenger vehicle, in a schematic top view. The vehicle 1 comprises a selection device 2, which is used to select different driver assistance functions of the vehicle 1.

In the present case, it is presumed that the vehicle 1 can be equipped according to a first equipment variant or a second equipment variant. In the first equipment variant, the vehicle 1 comprises a speed limiter as a first driver assistance function. In this speed limiter, which can also be referred to as a limiter, a speed limit can be set by the driver, for example, so as not to exceed the permissible highest speed during the journey with the vehicle 1.

In the second equipment variant the vehicle 1 has an adaptive speed regulation or ACC as the second driver assistance function in addition to the first driver assistance function. In this second driver assistance function, a permissible highest speed or set speed can also be specified. Furthermore, this second driver assistance function can automatically set the distance or safety distance to a road user traveling ahead and can adapt the speed to below the set speed for this purpose.

The selection device 2 comprises an electronic control unit 3 and a multifunction steering wheel 4. The multifunction steering wheel 4 comprises an operating element 5, which can be operated by a driver of the vehicle 1. It is typically provided that the multifunction steering wheel 4 has a plurality of operating elements 5. The operating element 5 can be dynamically occupied. This means that a display assigned to the operating element 5 can be adapted by means of the control unit 3. It can moreover be set by means of the control unit 3 which of the driver assistance functions is activated upon actuation of the operating element 5. This is schematically illustrated by the arrow 6.

The operating concept can be simplified due to the option of hiding operating elements 5 or dynamically adapting the display of the operating element 5. If, for example, no ACC is present in the vehicle 1 according to the first equipment variant, the display assigned to the first driver assistance function or the speed limiter is displayed on the multifunction steering wheel 4 or the operating element 5. For example, for this purpose the symbol “LIM” can be displayed on the multifunction steering wheel 4 or the operating element 5. In addition, the control by means of the control unit 3 can be provided in such a way that upon the operation of the operating element 5, the first driver assistance function or the speed limiter is activated.

However, if the vehicle 1 is equipped according to the second equipment variant and the adaptive speed regulation (ACC) is present in addition to the speed limiter, in the base state, the symbol “ACC” is on the multifunction steering wheel 4 or the operating element 5, but the symbol “LIM” is no longer. Upon the operation of the operating element 5, the driver can then activate the ACC, but no longer the speed limiter or limiter.

It can also be provided that in the second equipment variant, in which the limiter function or the first driver assistance function can no longer be operated directly on the multifunction steering wheel 4, a setting menu is displayed to the driver. The display which is assigned to the operating element 5 and also the driver assistance function to be activated upon the operation of the operating element 5 can then be set by the driver by means of an input device 7. For example, the driver can select the occupancy in such a way that both “LIM” and “ACC” are displayed on the multifunction steering wheel 4 or the operating element 5. In this case, both driver assistance functions are also operable by the driver by actuating the operating element 5.

In the second equipment variant, in which only the adaptive speed regulation or the ACC is activatable on the multifunction steering wheel 4 or the operating element 5, the speed limiter is no longer directly activatable by the driver. Since the speed limiter is thus not directly visible to the driver in this constellation, the speed behavior of the driver can be observed. Information from a detection unit 8 of the selection device 2 can be used for this purpose. This information can specify, for example, whether the driver often drives faster than the speed limit permitted on the roadway section. In this case, a notification of the activatable speed limiter can be displayed to the driver. Alternatively thereto, it can be provided that the setting for the speed limiter is automatically activated so that the inscription “LIM” is visible on the multifunction steering wheel 4 and the limiter is activated upon actuation of the operating element 5.

It can furthermore be provided that information on a change of the first equipment variant, for example, a change from the first equipment variant to the second equipment variant or also a change from the second equipment variant to the first equipment variant are detected by means of the selection device 2. If such a change is recognized, the display assigned to the operating element 5 and also the driver assistance function assigned to the operating element 5 can be automatically changed by means of the control unit 2.

1-7. (canceled)

8. A selection device for driver assistance functions of a vehicle, comprising:
a multifunction steering wheel having an operating element, wherein a display assigned to the operating element and a driver assistance function assigned to the operating element are settable; and
a control unit configured to control the display and to activate and/or deactivate the driver assistance function upon operation of the operating element, wherein the control unit is further configured such that:
in a first equipment variant of the vehicle, which comprises a first driver assistance function, the control unit controls the display to display a first display assigned to the first driver assistance function and to activate and/or deactivate the first driver assistance function upon the operation of the operating element, and
in a second equipment variant of the vehicle, which comprises the first driver assistance function and a second driver assistance function, the control unit controls the display to display a second display assigned to the second driver assistance function and to activate and/or deactivate the second driver assistance function upon the operation of the operating element.

9. The selection device of claim 8, wherein the first driver assistance function is a speed limiter and the second driver assistance function is an adaptive speed regulation.

10. The selection device of claim 9, wherein the selection device is configured to detect information about exceeding of the permissible highest speed and, depending on the detection, to display the first display and to activate the first driver assistance function upon actuation of the operating element.

11. The selection device of claim 8, wherein the selection device has an input unit, by means of which the display and/or the function assigned to the operating element are settable.

12. The selection device of claim 8, wherein the selection device is configured to detect a change from the first equipment variant to the second equipment variant and, upon the detected change, to display the second display and to activate and/or deactivate the second driver assistance function upon an operation of the operating element.

13. A vehicle comprising the selection device of claim 8.

14. A method for operating a selection device for driver assistance functions of a vehicle, comprising:
providing a multifunction steering wheel having an operating element, wherein a display assigned to the operating element and a driver assistance function assigned to the operating element are settable, and
controlling the display to activate and/or deactivate the driver assistance function upon operation of the operating element, such that:
in a first equipment variant of the vehicle, which comprises a first driver assistance function, a first display assigned to the first driver assistance function is displayed and the first driver assistance function is activated and/or deactivated upon operation of the operating element, and
in a second equipment variant of the vehicle, which comprises the first driver assistance function and the second driver assistance function, a second display assigned to the second driver assistance function is displayed and the second driver assistance function is activated and/or deactivated upon an operation of the operating element.
